(19) United States
(12) Patent Application Publication
(10) Pub. No.: US 2006/0077471 A1
(43) Pub. Date: Apr. 13, 2006

(54) System and method of digital engraving

(75) Inventor: Chun-Yi Wang, Taipei City (TW)

Correspondence Address: BIRCH STEWART KOLASCH & BIRCH, PO BOX 747, FALLS CHURCH, VA, 22040-0747, US

(73) Assignee: ULEAD SYSTEMS, INC.

(21) Appl. No.: 10/960,972

(22) Filed: Oct. 12, 2004

(51) Int. Cl. B41C 1/04

(52) U.S. Cl. 358/3.29

(57) ABSTRACT

A method of digital engraving. First, a source image is obtained. Next, brightness and contrast of the source image are adjusted. At least one layer corresponding to the source image is then generated according to an engraving line, generated according to a selected line pattern. Finally, the layer is merged to a target image and the target is then output.

### BACKGROUND

The present invention relates to an image processing system and method, and in particular to a system and method of digital engraving for image authoring. The engraving effect converts a source image to an engraved-like image.

Victor Ostromoukhov, disclosing “Digital Facial Engraving,” SIGGRAPH 1999, presents a system to create Digital Facial Engraving. In this system, a lot of effort and time have to be put in to produce an engraving image. A face, for example, is manually segmented, parametric grids are morphed to fit the surface's geography, and those layers are merged with different merging styles. The engraving process, however, in this system requires much processing time and effort to generate engraving images.

Thus, the invention presents a simple system requiring less user participation to generate digital engraving from an input image.

### SUMMARY

Accordingly, an embodiment of the invention provides a method of digital engraving, simply and rapidly generating high-quality digital engraving images.

Accordingly, an embodiment of the invention discloses a method of digital engraving. First, a source image is obtained and converted to a grayscale image or any other applicable format file. Edges of the source image are extracted and stored in a buffer. Next, the maximum and minimum grayscale ranges of the grayscale image is set, the brightness and contrast of the grayscale image are adjusted for generating a more convincing engraved image, line patterns are selected, and engraving lines are generated procedurally based on the selected line patterns and the grayscale ranges, thus generating layers corresponding to the source image. Next, generated layers are merged directly on a target image or on a mask, edges of the target image are emphasized once again using the extracted stored in the buffer, and finally the target image is output.

An embodiment of the present invention further provides a system of digital engraving. The system comprises a data extracting unit and a data processing unit.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a flowchart showing the method of digital engraving according to an embodiment of the invention;

FIG. 2 is a flowchart showing the detailed steps of the layer generation according to an embodiment of the invention;

FIGS. 3 and 4 are schematic diagrams showing straight lines of the engraving patterns with different angles relating to engraving patterns according to an embodiment of the invention;

FIG. 5 is a schematic diagram showing circles relating to the engraving patterns according to an embodiment of the invention;

FIG. 6 is a schematic diagram showing sine waves relating to the engraving patterns according to an embodiment of the invention;

FIG. 7 is a schematic diagram showing a source image for digital engraving;

FIG. 8 is a schematic diagram showing an example of digital engraving with two merged layers of the source image shown in FIG. 7 according to an embodiment of the invention;

FIG. 9 is a schematic diagram showing another source image for digital engraving;

FIG. 10 is a schematic diagram showing an example of digital engraving of the source image shown in FIG. 9 according to an embodiment of the invention, in which the color of the image is plain black-and-white;

FIG. 11 is a schematic diagram showing another example of digital engraving of the source image shown in FIG. 9 according to an embodiment of the invention, in which the image is painted by source pixel colors; and

FIG. 12 is a schematic diagram showing the architecture of the engraving system according to an embodiment of the invention.

### DETAILED DESCRIPTION

The present invention discloses a method of digital engraving, generating a digital engraving image from a source image. Engraving lines are smooth and generated procedurally, and the widths thereof represent grayscale ranges of the source image. An engraving system of the invention can be full automatic or semi-automatic with very less user participation for generating different engraving styles. The line patterns, line density, and line colors can be manually determined or system predefined. Multiple layers of a line can be generated and merged using different merging methods, generating different engraving results. In addition, both tones and edges of the source image can be preserved.

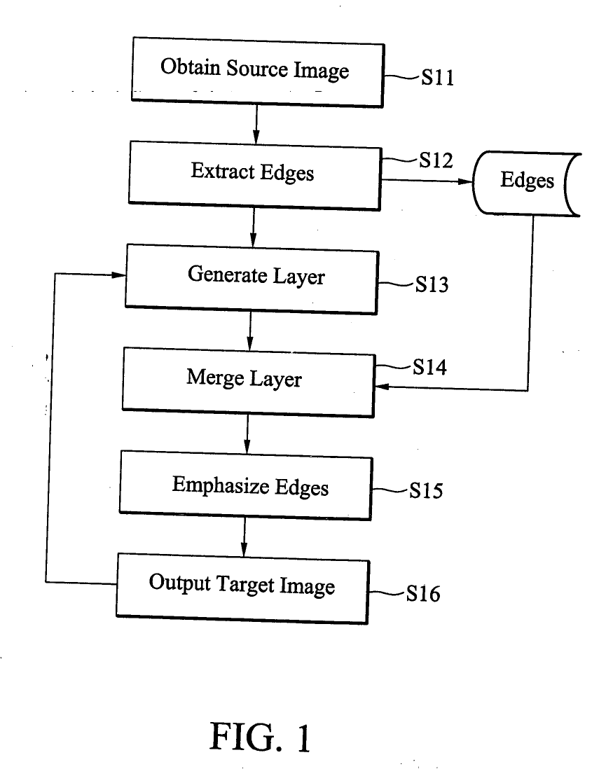

FIG. 1 is a flowchart showing the method of digital engraving according to an embodiment of the present invention.

In step S11, a source image is obtained.

In step S12, edges of the source image are extracted using a method, such as Canny algorithm, for preserving high-frequency details and edges thereof, and the edges are stored in a buffer.

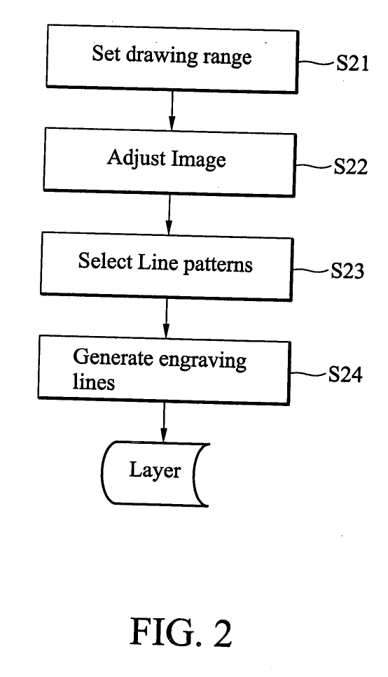

In step S13, a layer corresponding to the source image is generated. The number of generated layers can be manually determined or predefined by the engraving system of the invention. Layer generation further comprises the following steps, as shown in FIG. 2.

In step S21, the source image is converted to a grayscale image and the maximum and minimum grayscale ranges thereof can be set automatically by the engraving system or manual determination. A drawing, for example, with grayscale value ranged from 25 to 125 indicates only pixels with grayscale values within the range are available for generating engraving lines.

In step S22, the brightness and contrast of the grayscale image are adjusted, obtaining values of image parameters for generating a more convincing engraved image. The values of the image parameters are stored in the buffer. The adjustment can be performed either manually or automatically by the engraving system. In addition, the source image can be converted to any other applicable format image. An Edge-Preserving Blur technique is further used to smooth out the grayscale image for creating smoother engraving lines.

In step S23, line patterns are selected either manually or automatically by the engraving system.

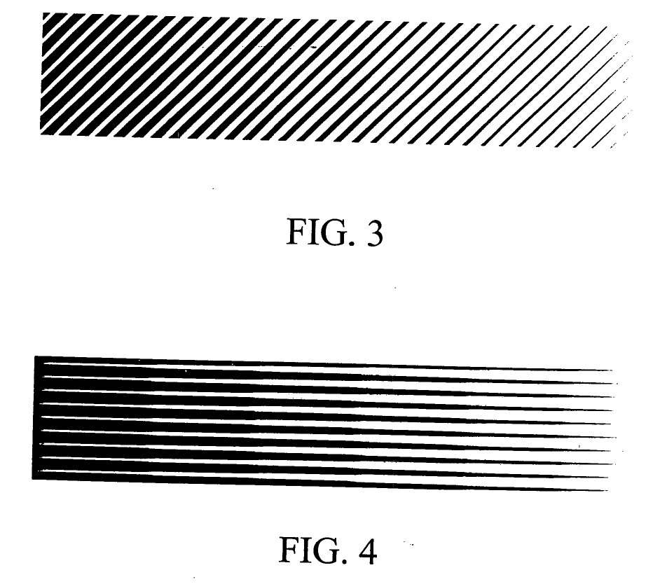

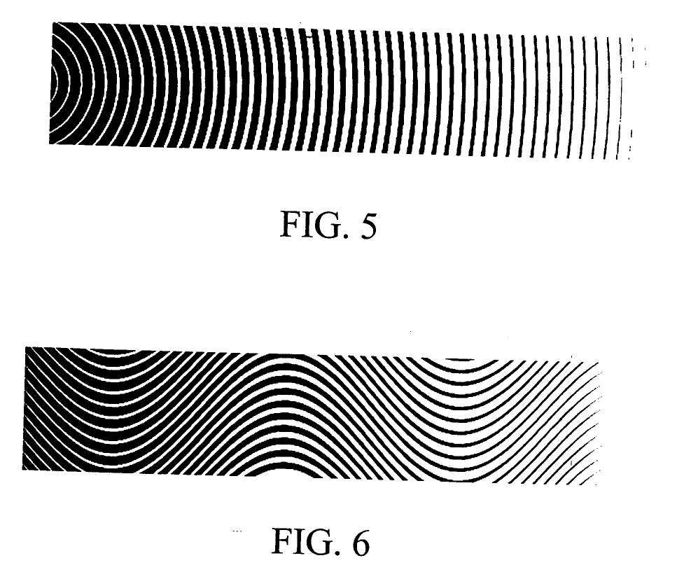

In step S24, engraving lines are generated procedurally based on the selected line patterns and grayscale values of the line patterns, as shown in FIG. 3 FIG. 6. FIGS. 3 and 4 illustrate straight lines of the engraving patterns with different angles relating to engraving patterns. FIG. 5 illustrates circles relating to the engraving patterns. FIG. 6 illustrates sine waves relating to the engraving patterns. A layer is generated in accordance with a generated engraving line and stored in the buffer. Engraving lines are smooth and the widths thereof represent the source grayscale value of the grayscale image. A line, for example, on top of a pixel of grayscale 25 is wider than the one on top of a pixel of grayscale 200. In addition, an anti-aliasing technique is applied to generate smooth-looking engraving lines. Further, the engraving lines can be rendered directly to a target image or a mask for later merging process.

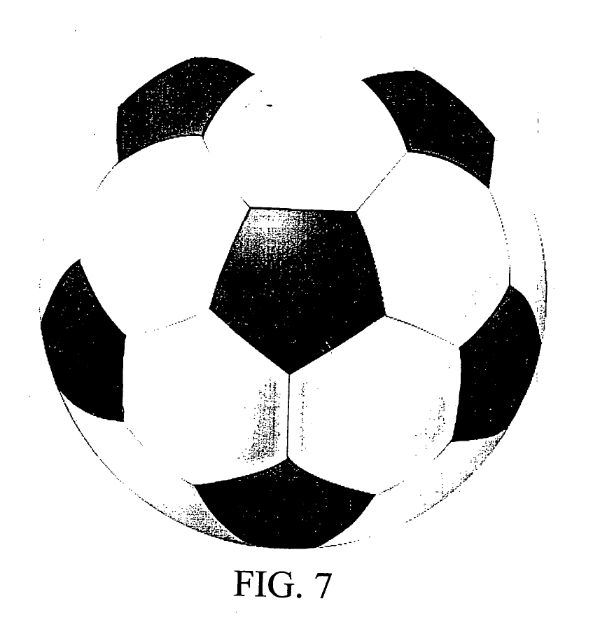

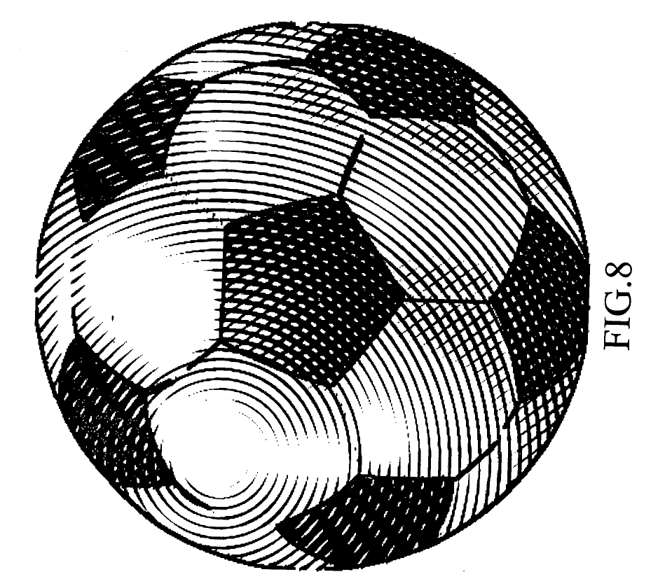

In step S14, layers, if more than one, are merged directly to the target image or mask. FIG. 7 illustrates a source image for digital engraving and FIG. 8 illustrates a digital engraving image with two merged layers of the source image shown in FIG. 7. The number of layers for merging process can be set either manually or automatically.

In step S15, edges of the target image are emphasized using the extracted edges stored in the buffer, increasing grayscale values of edge pixels. The edges can be added to the target image or mask.

In step S16, the target image with the rendered engraving lines is output. The mask is merged to the target image when the engraving lines are rendered to the mask. The color of an engraving line and the background of the engraving line is plain black-and-white, user-defined single color, or source pixel color.

In addition, more layers are generated and merged by repeating the generating and merging steps, thus generating a high-quality digital engraving image.

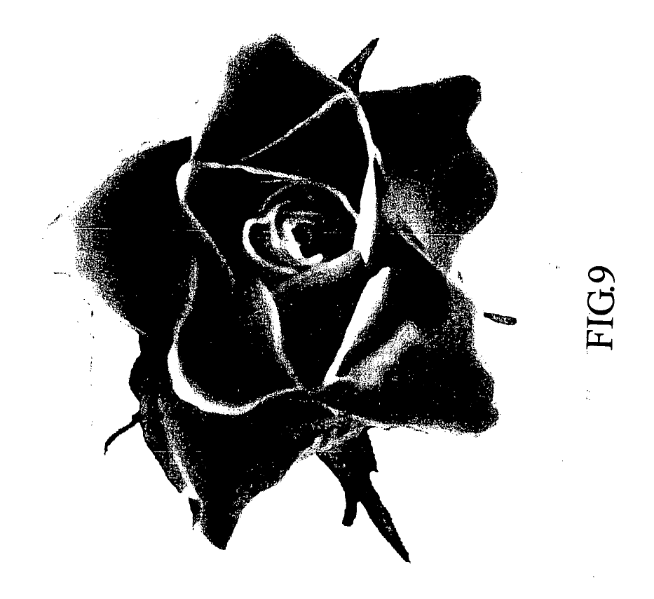

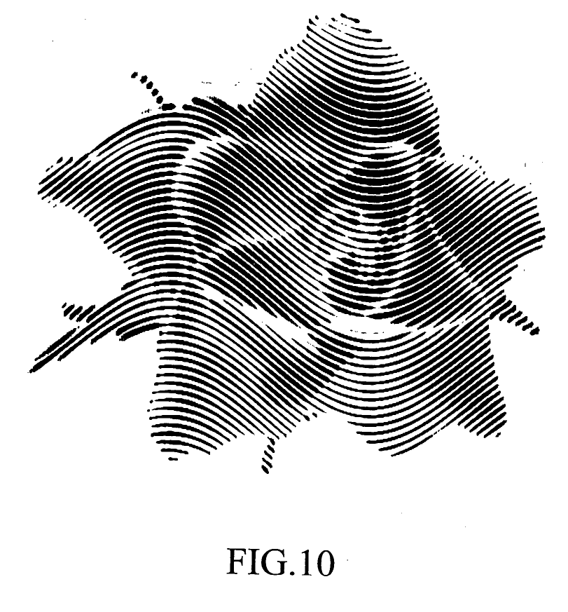

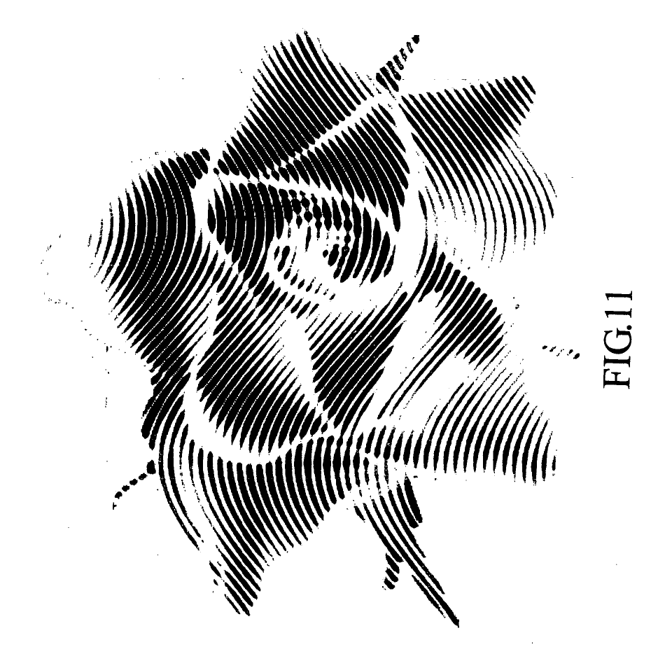

FIG. 9 illustrates another source image for digital engraving. FIG. 10 illustrates an example of digital engraving of the source image shown in FIG. 9 according to an embodiment of the invention, in which the color of the engraving image is plain black-and-white. FIG. 11 illustrates another example of digital engraving of the source image shown in FIG. 9 according to an embodiment of the invention, in which the engraving image is painted by the source pixel colors.

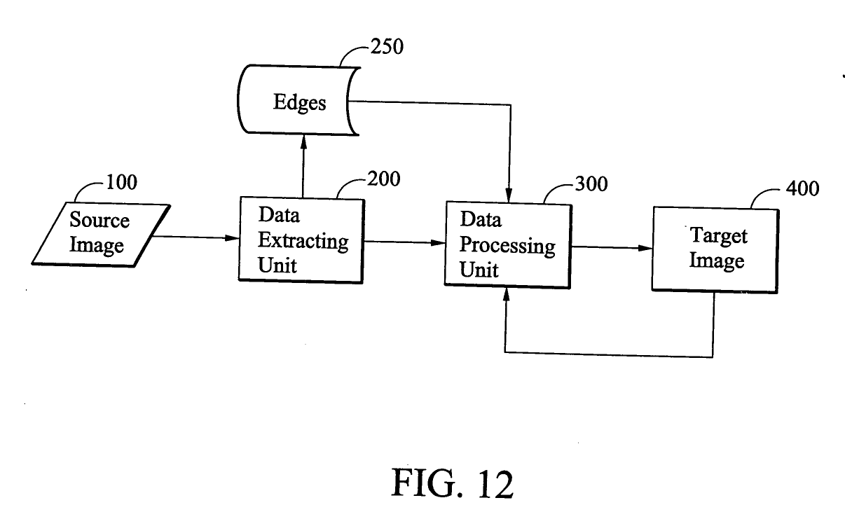

FIG. 12 is a schematic diagram showing the architecture of the engraving system according to an embodiment of the invention, comprising a data extracting unit 200 and a data processing unit 300.

Data extracting unit 200 obtains a source image 100. Data processing unit 300 extracts edges 250 of the source image and the edges are stored in a buffer. Next, data processing unit 300 converts the source image to a grayscale image and adjusts the brightness and contrast of the grayscale image for obtaining values of image parameters. The values of the image parameters are stored in the buffer. Next, data processing unit 300 generates engraving lines procedurally based on selected line patterns and grayscale values of the line patterns, thus generating at least one layer corresponding to the source image in accordance with a generated engraving line. The generated layer is stored in the buffer.

Next, data processing unit 300 merges generated layers to the target image or mask, emphasizes edges of the target image are using the extracted edges stored in the buffer, and outputs the target image with the rendered engraving lines.

Embodiments of the invention generate a digital engraving image from an input image with different engraving styles created by varying line patterns and merging methods. The invention is simple and efficient and can be applied to digital image or video processing.

While embodiments of the invention have been described by way of example and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of digital engraving, comprising:
obtaining a source image;
generating at least one layer corresponding to the source image;
merging the layer on a target image; and
outputting the target image.

2. The method as claimed in claim 1, wherein the layer creation further comprises:
converting the source image to a grayscale image;
setting the maximum and minimum grayscale ranges of the source image;
adjusting the brightness and contrast of the source image;
selecting a line pattern corresponding to the source image;
generating an engraving line according to the selected line pattern and grayscale ranges; and
generating a layer corresponding to the source image according to the generated engraving line.

3. The method as claimed in claim 2, further comprising extracting edges of the source image.

4. The method as claimed in claim 3, wherein edges of the target image are further enhanced using the extracted edges.

5. The method as claimed in claim 4, wherein the edge extraction preserves high-frequency details of the source image.

6. The method as claimed in claim 2, wherein the line pattern is selected manually or system predefined.

7. The method as claimed in claim 2, wherein after the engraving line is rendered to a mask, the mask is merged to the target image.

8. The method as claimed in claim 2, wherein a color of the engraving line of the target image is plain black-and-white, user-defined single color, or source pixel color.

9. A storage medium for storing a computer program providing a method of digital engraving, comprising using a computer to perform the steps of:
obtaining a source image;
generating at least one layer corresponding to the source image;
merging the layer on a target image; and
outputting the target image.

10. The storage medium as claimed in claim 9, wherein the layer creation further comprises:
converting the source image to a grayscale image;
setting the maximum and minimum grayscale ranges of the source image;
adjusting the brightness and contrast of the source image;
selecting a line pattern corresponding to the source image;
generating an engraving line according to the selected line pattern and grayscale ranges; and
generating a layer corresponding to the source image according to the generated engraving line.

11. The storage medium as claimed in claim 10, further comprising extracting edges of the source image.

12. The storage medium as claimed in claim 11, wherein edges of the target image are further enhanced using the extracted edges.

13. The storage medium as claimed in claim 12, wherein the edge extraction preserves high-frequency details of the source image.

14. The storage medium as claimed in claim 10, wherein the line pattern is selected manually or system pre-defined.

15. The storage medium as claimed in claim 10, wherein after the engraving line is rendered to a mask, the mask is merged to the target image.

16. The storage medium as claimed in claim 10, wherein a color of the engraving line of the target image is plain black-and-white, user-defined single color, or source pixel color.

17. An engraving system of digital engraving, comprising:
a data extracting unit, obtaining a source image; and
a data processing unit, coupled to the data extracting unit, generating at least one layer corresponding to the source image, merging the layer on a target image, and outputting the target image.

18. The system as claimed in claim 17, wherein the data processing unit further converting the source image to a grayscale image, setting the maximum and minimum grayscale ranges of the source image, adjusting the brightness and contrast of the source image, selecting a line pattern corresponding to the source image, generating an engraving line according to the selected line pattern and grayscale ranges, and generating a layer corresponding to the source image according to the generated engraving line.

19. The system as claimed in claim 18, wherein the data processing unit further extracting edges of the source image and enhancing the target image using the extracted edges.

20. The method as claimed in claim 18, wherein after the engraving line is rendered to a mask, the mask is merged to the target image.
